(19) United States
(12) Patent Application Publication
(10) Pub. No.: US 2026/0288676 A1
(43) Pub. Date: Sep. 24, 2026

(54) Minimal Recognition Overhead Computing Architecture: Systems and Methods for High-Efficiency Computing Leveraging Recognition Physics Principles

(71) Applicant: Jonathan Washburn, Austin, TX (US)

(72) Inventor: Jonathan Washburn, Austin, TX (US)

(21) Appl. No.: 19/570,433

(22) Filed: Mar. 18, 2026

Related U.S. Application Data
(60) Provisional application No. 63/774,215, filed on Mar. 19, 2025.

(51) Int. Cl. G06F 15/82

(52) U.S. Cl. CPC G06F 15/82

(57) ABSTRACT

Systems, methods, apparatus, and non-transitory computer-readable media are disclosed for recognition-based computing control. In some embodiments, one or more metrics associated with one or more computational entities or runtime conditions are normalized to obtain one or more dimensionless recognition metrics. One or more recognition coverage values are computed according to F_cov(r)=r/(r+X_opt), where r is a dimensionless recognition metric and X_opt is a positive informational scale. One or more machine-control outputs are generated from the one or more recognition coverage values and are used to control one or more computing subsystems. In various embodiments, the one or more computing subsystems may include task scheduling, resource allocation, workload partition sizing, reconfigurable hardware allocation, accelerator assignment, neuromorphic control, adaptive parameter optimization, or combinations thereof.

### CROSS-REFERENCE TO RELATED APPLICATIONS

This application claims the benefit of U.S. Provisional Patent Application No. 63/774,215, filed Mar. 19, 2025, titled “Minimal Recognition Overhead Computing Architecture: A System and Method for High-Efficiency Computing Leveraging Recognition Physics Principles,” the entirety of which is incorporated herein by reference.

### BACKGROUND

The present invention relates generally to computing systems, computer architectures, and computational control frameworks, and more particularly to systems, methods, apparatus, and non-transitory computer-readable media for improving computing efficiency, resource utilization, scheduling behavior, hardware allocation, memory management, partition management, accelerator assignment, and adaptive runtime optimization through use of recognition-based control functions.

In representative embodiments, the invention applies to task scheduling, resource allocation, workload partition sizing, reconfigurable hardware assignment, multicore and accelerator allocation, neuromorphic computing control, adaptive parameter optimization, and combinations thereof.

In various embodiments, the invention may be implemented in connection with FPGA-based accelerators, multi-core CPU systems, GPU systems, ASIC platforms, neuromorphic computing devices, cloud and distributed computing infrastructure, edge and Internet-of-Things devices, embedded systems, automotive computing platforms, aerospace computing platforms, and high-performance computing clusters.

Modern computing systems continue to exhibit inefficiencies arising from subsystem-specific heuristics, static control rules, and uniform allocation policies that do not account for differences in computational significance, workload complexity, resource urgency, memory behavior, hardware constraints, or changing system state. These inefficiencies appear across scheduling, resource distribution, partitioning, hardware assignment, adaptive control, and related runtime behaviors.

In task scheduling, common schedulers such as round-robin schedulers, first-come-first-served schedulers, and conventional priority-queue approaches typically treat tasks within a given class or band in a substantially uniform manner, often without a principled and bounded mapping from measured task characteristics to runtime dispatch priority. As a result, head-of-line blocking, priority inversion, unfair latency behavior, and reduced throughput can occur.

In resource allocation, conventional approaches frequently rely on fixed quotas, manually tuned weights, or local heuristics when distributing processor time, bandwidth, memory capacity, cache capacity, storage throughput, and accelerator resources. Such approaches often fail to distinguish adequately between tasks or processes having substantially different operational significance, memory behavior, urgency, or expected contribution to overall system performance.

In workload partitioning, static chunk sizes, hand-tuned minibatch sizes, or heuristic partition rules are commonly selected without a general mathematical control law that relates partition size to the complexity, significance, or operational weight of the work being partitioned. This can reduce parallel efficiency, produce poor load balancing, and increase scheduling and coordination overhead.

In reconfigurable hardware and accelerator design, logic cells, DSP slices, block memory resources, routing regions, and related structures are commonly assigned according to fixed floor plans, coarse templates, or designer intuition. Similar limitations arise in CPU core assignment, GPU execution-unit assignment, accelerator occupancy allocation, and other heterogeneous computing contexts in which control decisions are often fragmented across separate subsystems and tuning regimes.

In neuromorphic systems and neural hardware, connection strengths, synaptic parameters, and pathway influence are commonly determined by Hebbian rules, gradient-based procedures, or heuristic salience mechanisms. Conventional systems do not provide a unified recognition-based control rule for scaling weights or pathway influence according to pathway connectivity strength or related recognition measures while remaining compatible with broader computing-control architectures.

In adaptive optimization, computing systems frequently use ad hoc feedback loops, empirical hysteresis thresholds, manually selected tuning schedules, or coarse trial-and-error parameter sweeps for functions such as dynamic voltage and frequency scaling, thread-pool adjustment, cache partition control, runtime power management, memory-bandwidth allocation, and accelerator configuration. These approaches often require repeated manual retuning across platforms and workloads.

Accordingly, there remains a need for a unified computing control architecture that provides a bounded, monotonic, implementation-ready mapping from normalized system metrics to concrete control actions across multiple layers of a computing system. There further remains a need for such an architecture to operate across diverse hardware and software environments while reducing dependence on unrelated subsystem-specific tuning rules.

In some embodiments, a recognition coverage function may be defined as F_cov(r)=r/(r+X_opt), where r is a non-negative dimensionless recognition metric and X_opt is an optimal informational scale.

In some embodiments, the optimal informational scale may be defined as X_opt=phi/pi.

In some embodiments, the dimensionless recognition metric r may be obtained according to r=metric/metric_scale.

In this manner, the recognition metric r and the optimal informational scale X_opt may be dimensionally compatible, thereby supporting use of the recognition coverage function as a common control law across multiple subsystem families.

There remains a further need for systems and methods that apply such a recognition coverage function across multiple subsystem families including task scheduling, resource allocation, partition sizing, reconfigurable hardware assignment, multicore and accelerator allocation, neuromorphic control, and adaptive runtime optimization.

### BRIEF SUMMARY OF THE INVENTION

The present invention provides systems, methods, apparatus, and non-transitory computer-readable media that implement a recognition-based computing control architecture for improving efficiency, boundedness of control behavior, resource utilization, and runtime adaptability across one or more computing subsystems.

In some embodiments, one or more measured, estimated, predicted, or derived system metrics may be normalized to produce a dimensionless recognition metric r, and a recognition coverage value may be computed according to F_cov(r)=r/(r+X_opt), where X_opt may in some embodiments be defined as phi/pi.

In some embodiments, the recognition coverage value may be used to determine task priority, resource-allocation weight, workload partition size, hardware allocation level, multicore or accelerator assignment level, neuromorphic weight scaling, adaptive parameter updates, or combinations thereof.

In some embodiments, task scheduling may be controlled by computing a priority value for each task based on a recognition metric associated with the task, thereby enabling bounded and monotonic task-priority assignment from normalized task characteristics.

In some embodiments, resource allocation may be controlled by computing allocation weights from respective recognition metrics and distributing available computing resources according to the resulting weights. In various implementations, the resources may include processor time, memory bandwidth, cache capacity, storage throughput, network bandwidth, accelerator occupancy, logic resources, or combinations thereof.

In some embodiments, workload partition sizing may be controlled according to a recognition-derived partition rule so that partition size reflects workload magnitude, complexity, or significance in a bounded and implementation-ready manner.

In some embodiments, reconfigurable hardware resources including logic cells, DSP slices, and memory resources may be allocated according to recognition-derived coverage values, thereby permitting mathematically guided scaling of hardware assignments across one or more kernels, pipelines, tasks, or accelerators.

In some embodiments, multicore, GPU, and accelerator assignments may be controlled according to recognition-derived values associated with one or more tasks, threads, jobs, or execution units.

In some embodiments, neuromorphic pathway weights, synaptic strengths, spike intensities, or related neural-computing parameters may be scaled according to recognition-derived coverage values associated with connection strength, pathway importance, or related metrics.

In some embodiments, adaptive runtime optimization may be performed by updating one or more operating parameters according to a recognition-derived update rule, thereby enabling self-adjusting control of runtime parameters including frequency, voltage, cache allocation, thread-pool size, memory parameters, and accelerator-control variables.

In some embodiments, the disclosed architecture may be implemented in software, firmware, hardware, reconfigurable logic, application-specific integrated circuits, cloud orchestration environments, distributed computing platforms, embedded systems, edge devices, or combinations thereof.

In some embodiments, the disclosed architecture may provide a common recognition-based control framework spanning multiple subsystem families, thereby reducing fragmentation among otherwise separate tuning regimes and improving consistency of control behavior across heterogeneous computing environments.

### BRIEF DESCRIPTION OF THE DRAWINGS

The foregoing and other objects, features, and advantages of the invention will become more apparent from the following detailed description, taken in conjunction with the accompanying drawings.

FIG. 1 is a block diagram of an example system for recognition-based computing control, including a computing node, one or more data stores, a network interface, and one or more managed computing environments, wherein a recognition metric module, a normalization module, a recognition coverage engine, and one or more control modules generate one or more machine-control outputs for controlling one or more computing subsystems.

FIG. 2 is a schematic flow diagram illustrating an example recognition-based task scheduling process in which recognition-derived priority values are used to control dispatch order, execution timing, or queue selection for one or more tasks.

FIG. 3 is a schematic diagram illustrating an example recognition-based resource-allocation process in which recognition-derived allocation weights are used to distribute one or more computing resources among competing tasks, processes, threads, jobs, or other computational entities.

FIG. 4 is a schematic diagram illustrating an example recognition-based workload partition-sizing process in which a workload magnitude, complexity, or related recognition metric is used to determine one or more partition sizes, partition counts, or sub-workload distributions.

FIG. 5 is a schematic diagram illustrating an example recognition-based hardware-allocation embodiment for reconfigurable hardware in which recognition-derived values are used to control allocation of logic resources, DSP resources, memory resources, routing resources, or reconfiguration regions.

FIG. 6 is a schematic diagram illustrating an example recognition-based accelerator-assignment embodiment in which recognition-derived values are used to control multicore assignment, GPU assignment, neuromorphic pathway scaling, synaptic scaling, or related processing-resource allocation.

FIG. 7 is a schematic flow diagram illustrating an example recognition-based adaptive parameter optimization process in which one or more operating parameters are iteratively updated according to a recognition-derived update rule.

FIG. 8 is a schematic diagram illustrating an example software and cloud implementation architecture in which the disclosed recognition-based control framework is embodied in software, firmware, distributed services, cloud orchestration infrastructure, or combinations thereof.

### DETAILED DESCRIPTION OF THE INVENTION

Reference will now be made in detail to various embodiments of the present invention, examples of which are illustrated in the accompanying drawings. While the invention will be described in conjunction with representative embodiments and implementations, it will be understood that the invention is not limited to those embodiments and implementations. On the contrary, the invention is intended to cover alternatives, modifications, and equivalents as may be included within the spirit and scope of the invention.

In the following description, numerous specific details are set forth in order to provide a thorough understanding of embodiments of the present invention. It will be apparent, however, to one of ordinary skill in the art that embodiments of the present invention may be practiced without one or more of these specific details, or with other methods, components, materials, or structures. In other instances, well-known structures, materials, or operations have not been shown or described in detail so as not to obscure aspects of the invention unnecessarily.

In various embodiments, the present invention provides a recognition-based computing architecture in which one or more normalized recognition metrics are transformed into one or more recognition coverage values that are used to control one or more computing subsystems. In representative embodiments, the controlled subsystems may include task scheduling, resource allocation, workload partition sizing, hardware allocation, accelerator assignment, neuromorphic control, adaptive parameter optimization, software-based deployment control, cloud-based deployment control, or combinations thereof.

As used herein, ‘computational entity’ includes a task, process, thread, kernel, job, container, virtual machine, service request, accelerator kernel, memory client, network client, storage client, or other executable or resource-consuming computing object.

As used herein, ‘metric’ means a measured, estimated, inferred, predicted, or profiled quantity associated with a computational entity or runtime condition, including at least one of instruction count, expected execution time, queue depth, dependency count, memory footprint, cache-access value, reuse value, bandwidth demand, accelerator occupancy, pathway strength, temperature, power consumption, latency, throughput, utilization, contention, or quality-of-service values.

As used herein, ‘metric_scale’ means a strictly positive scaling quantity used to normalize a metric to a dimensionless value. In non-limiting examples, metric_scale comprises a fixed constant, a profiled baseline, a rolling average, a percentile value, a class-dependent baseline, or a workload-dependent baseline.

As used herein, ‘recognition metric r’ means a non-negative dimensionless value computed as metric/metric_scale, optionally after combining multiple metrics into a composite metric.

As used herein, ‘recognition coverage value’ means a bounded value computed from r using F_cov(r)=r/(r+X_opt), wherein X_opt is a positive informational scale.

As used herein, ‘machine-control output’ means an output that directly controls a computing subsystem, including a task priority value, an allocation weight, a partition size or count, a hardware resource assignment, a processing-resource assignment, a pathway-scaling value, an operating-parameter update, or an orchestration action.

As used herein, ‘verification metric’ means a post-control measurement used to validate the effect of a machine-control output, including latency, throughput, utilization, energy consumption, temperature, contention, missed-service indicators, or quality-of-service values.

In some embodiments, a machine-control output is retained when a verification metric satisfies a baseline, target, or threshold; otherwise the machine-control output is reduced, reverted, or clamped.

In representative embodiments, the recognition coverage function and associated generation of machine-control outputs may be applied to any one computing subsystem or to any combination of computing subsystems described herein. The disclosed embodiments share a common inventive concept in that a normalized recognition metric r is transformed into a bounded recognition coverage value F_cov(r), and the bounded recognition coverage value is used to generate machine-control outputs that control one or more computing subsystems.

In some embodiments, a recognition coverage function may be defined in ASCII form as F_cov(r)=r/(r+X_opt), where r is a non-negative dimensionless recognition metric and X_opt is a positive informational scale. In some embodiments, X_opt may be defined as phi/pi. In some embodiments, r and X_opt are selected such that F_cov(r) is bounded between 0 and 1 and increases monotonically with increasing r.

In some embodiments, the recognition metric r may be obtained by normalizing one or more measured, estimated, predicted, inferred, profiled, or otherwise derived quantities associated with a task, process, thread, workload, hardware function, pathway, system state, runtime condition, or combinations thereof. In one example, the recognition metric r may be obtained according to r=metric/metric_scale.

In some embodiments, the recognition coverage value F_cov(r) may be bounded between zero and one for non-negative values of r, and may increase monotonically with increasing values of r. In this manner, the recognition coverage function may provide a bounded and implementation-ready mapping from normalized system metrics to concrete control outputs used by one or more computing subsystems.

By way of non-limiting example, a task scheduling subsystem may determine metric as a queue-depth value of 40 pending tasks for a first queue, and may determine metric_scale as a baseline queue-depth value of 20 tasks, such that r=metric/metric_scale=2. A recognition coverage value may then be computed as F_cov(r)=r/(r+X_opt). For an illustrative X_opt of 1, F_cov(r)=2/3. In some embodiments, the scheduler may generate a machine-control output comprising a task priority value or allocation weight proportional to F_cov(r), such that the first queue receives increased dispatch preference relative to a second queue having a lower recognition coverage value.

In some embodiments, a recognition metric may correspond to a task-complexity measure, workload-size measure, queue-depth measure, dependency measure, memory-footprint measure, cache-access measure, reuse measure, bandwidth-demand measure, hardware-significance measure, pathway-strength measure, operating-condition measure, thermal measure, power-consumption measure, latency measure, throughput measure, or another quantity indicative of relative computational significance, urgency, contribution, or control relevance.

In some embodiments, one or more recognition metrics may be derived from instruction counts, expected execution times, queue depths, dependency counts, memory footprints, reuse indicators, bandwidth-demand estimates, processing-core utilization values, accelerator occupancy values, pathway-strength values, temperature values, power-consumption values, telemetry values, runtime counters, profiler outputs, predictive model outputs, or combinations thereof.

In some embodiments, one or more raw or intermediate quantities may be normalized using a fixed scale, a profiled scale, a baseline-dependent scale, a rolling scale, a resource-class-dependent scale, a workload-dependent scale, or another normalization procedure suitable for producing a dimensionless recognition metric. In some embodiments, multiple recognition-relevant quantities may be combined to form a composite recognition metric using a weighted sum, weighted average, maximum function, minimum function, thresholded combination, staged combination, or another aggregation procedure.

In some embodiments, once a recognition coverage value has been computed, the recognition coverage value may be provided to one or more control modules configured to generate concrete computing-control outputs. Such outputs may include task-priority values, allocation weights, partition sizes, hardware-resource assignments, processing-core assignments, pathway-scaling values, adaptive parameter updates, cloud orchestration actions, software control outputs, or other machine-control outputs.

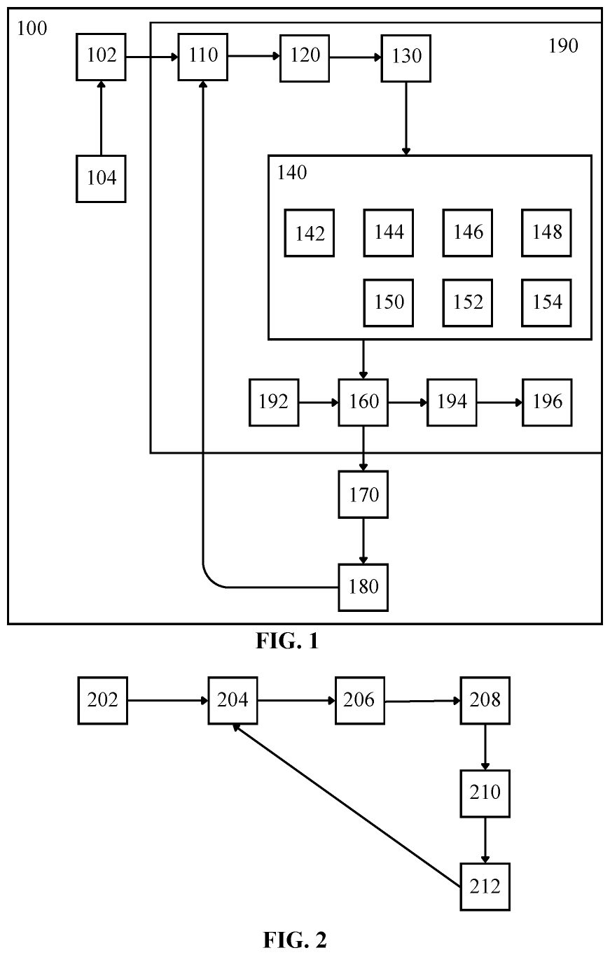

Turning now to FIG. 1, an example recognition-based computing architecture is illustrated. In some embodiments, system 100 may include a recognition metric module 110, a normalization module 120, a recognition coverage engine 130, and one or more control modules 140. In some embodiments, the one or more control modules 140 may include a task scheduling module 142, a resource-allocation module 144, a partition-sizing module 146, a hardware-allocation module 148, an accelerator-assignment module 150, an adaptive optimization module 152, a software and cloud control module 154, or combinations thereof.

In some embodiments, the accelerator-assignment module 150 may include multicore assignment logic, GPU assignment logic, neuromorphic control logic, or combinations thereof. In this manner, FIG. 1 may represent a unified architecture in which a common recognition-based control framework is applied across conventional processor allocation, accelerator allocation, and neuromorphic pathway control.

In some embodiments, the recognition metric module 110 may receive one or more workload descriptors, task descriptors, process descriptors, hardware-state inputs, system telemetry values, configuration values, performance-monitoring values, or other computing-state information 102 from one or more computing environments 104. In some embodiments, the computing environments 104 may include one or more processors, memory systems, accelerators, reconfigurable devices, storage systems, network interfaces, edge devices, embedded controllers, distributed computing nodes, cloud infrastructures, or combinations thereof.

In some embodiments, the recognition metric module 110 may determine one or more initial metric values associated with one or more computational entities or runtime conditions. The normalization module 120 may transform the one or more initial metric values into one or more dimensionless recognition metrics. The recognition coverage engine 130 may compute one or more corresponding recognition coverage values and provide the one or more recognition coverage values to the one or more control modules 140.

In some embodiments, the one or more control modules 140 may generate one or more control outputs 160 for controlling operation of one or more managed subsystems 170. In some embodiments, the managed subsystems 170 may include a scheduler, a processor allocator, a memory allocator, a cache controller, a partition manager, an FPGA configuration manager, a GPU assignment manager, a neuromorphic controller, a runtime optimization controller, a software runtime controller, a cloud orchestration controller, or combinations thereof.

In some embodiments, the managed subsystems 170 may further include one or more cache-allocation controllers, cache-partition controllers, memory-bandwidth controllers, memory-tier selection controllers, prefetch controllers, or combinations thereof. In such embodiments, one or more recognition coverage values may be used to control cache-way allocation, shared-cache partitioning, memory-channel allocation, memory-bandwidth throttling, tiered-memory placement, prefetch depth, eviction priority, or related memory-hierarchy behavior for one or more computational entities.

In some embodiments, a cache-access measure, reuse measure, memory-footprint measure, bandwidth-demand measure, locality measure, or combinations thereof may be used to derive one or more recognition metrics for memory-hierarchy control. The corresponding recognition coverage values may then be used to generate one or more cache-allocation outputs or memory-control outputs for controlling cache capacity, cache partition size, memory bandwidth, or memory placement among competing computational entities.

In this manner, the disclosed recognition-based computing architecture may improve not only scheduling and processing-resource assignment, but also memory-hierarchy behavior and cache utilization by using a common recognition-based control framework across processing, memory, and accelerator subsystems.

In some embodiments, one or more feedback signals 180 may be collected from the managed subsystems 170 or from the computing environments 104 and provided back to the recognition metric module 110 or the normalization module 120. In this manner, the disclosed architecture may operate in a closed-loop manner so that recognition metrics and corresponding control outputs may be updated in response to changing runtime conditions.

In some embodiments, the recognition-based computing architecture may be implemented wholly in software, wholly in hardware, wholly in firmware, or in any combination of software, hardware, and firmware. In some embodiments, one or more portions of the architecture may be implemented within an operating system, scheduler, hypervisor, runtime library, device driver, orchestration service, reconfigurable logic fabric, application-specific integrated circuit, or combinations thereof.

In some embodiments, the system 100 is implemented by one or more computing devices each comprising one or more processors and one or more memories storing executable instructions. When executed by the one or more processors, the executable instructions cause the computing device to perform operations of the recognition metric module 110, the normalization module 120, the recognition coverage engine 130, and the one or more control modules 140. In some embodiments, the computing device includes one or more interfaces including a network interface for receiving telemetry values, workload descriptors, or task descriptors, and for transmitting the machine-control outputs 160 to one or more managed subsystems. In some embodiments, the computing device includes one or more data stores configured to store the respective metrics, normalized recognition metrics, recognition coverage values, and machine-control outputs.

In the example of FIG. 1, the modules 110, 120, 130, and 140 execute on a computing node 190. The computing node 190 includes one or more data stores 192 configured to store metrics, normalized recognition metrics, recognition coverage values, and machine-control outputs. The computing node 190 further includes a network interface 194 configured to receive telemetry values, workload descriptors, or task descriptors, and to transmit machine-control outputs 160 to one or more managed computing environments 196.

Turning now to FIG. 2, an example recognition-based task scheduling process is illustrated. In some embodiments, one or more tasks 202 may be received by a task scheduling subsystem. The one or more tasks 202 may correspond to processes, threads, kernels, jobs, execution blocks, containers, virtual machines, service requests, or other executable computational entities.

In some embodiments, one or more task-related metrics 204 may be determined for the respective tasks 202. The one or more task-related metrics 204 may include task-size values, instruction-count values, estimated execution times, dependency counts, deadline values, queue-age values, latency-sensitivity values, memory-footprint values, or combinations thereof.

In some embodiments, the one or more task-related metrics 204 may be normalized to produce one or more dimensionless task recognition metrics 206. One or more recognition coverage values 208 may then be computed from the one or more task recognition metrics 206 using the recognition coverage function described herein.

In some embodiments, one or more task-priority values 210 may be generated from the one or more recognition coverage values 208. In some embodiments, a task-priority value may be set equal to a corresponding recognition coverage value. In other embodiments, a task-priority value may be further adjusted based on one or more dependency values, age values, deadline values, fairness values, starvation-control values, or combinations thereof.

In some embodiments, the one or more task-priority values 210 may be used to control dispatch order, queue selection, execution timing, execution frequency, preemption order, or other scheduler behavior for the tasks 202. In this manner, the scheduler may assign bounded and recognition-derived task priorities from normalized task characteristics rather than relying exclusively on static classes or manually tuned heuristic weights.

In some embodiments, after execution or partial execution of one or more tasks 202, one or more updated runtime values 212 may be collected and used to update the corresponding task-related metrics 204, the corresponding task recognition metrics 206, and the corresponding task-priority values 210. Accordingly, the task scheduling process of FIG. 2 may be performed iteratively or continuously during system operation.

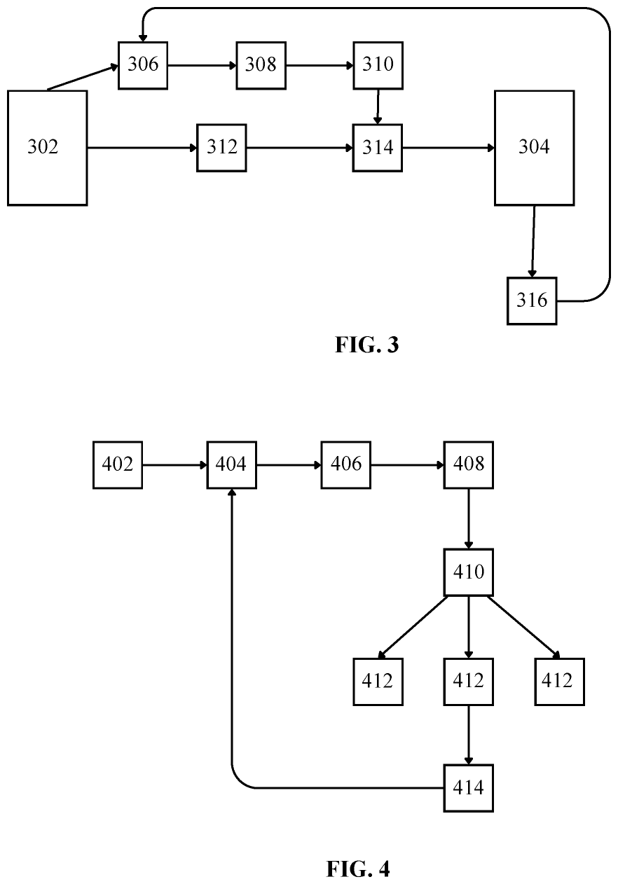

Turning now to FIG. 3, an example recognition-based resource-allocation process is illustrated. In some embodiments, one or more competing computational entities 302 may request access to one or more shared computing resources 304. The one or more computational entities 302 may include tasks, processes, threads, jobs, containers, virtual machines, accelerator kernels, memory clients, network clients, storage clients, or combinations thereof.

In some embodiments, one or more resource-relevant metrics 306 may be determined for the respective computational entities 302. The one or more resource-relevant metrics 306 may include processor demand, memory demand, cache demand, bandwidth demand, storage demand, latency-sensitivity values, throughput-sensitivity values, execution urgency, expected contribution values, or combinations thereof.

In some embodiments, the one or more resource-relevant metrics 306 may be normalized to produce one or more dimensionless recognition metrics 308. One or more recognition coverage values 310 may then be computed from the one or more dimensionless recognition metrics 308 using the recognition coverage function described herein.

In some embodiments, one or more allocation weights 312 may be generated from the one or more recognition coverage values 310. In one example embodiment, an allocation weight for a given computational entity may be based directly on the corresponding recognition coverage value. In other embodiments, the allocation weight may be further adjusted using one or more policy constraints, minimum allocation values, maximum allocation values, fairness constraints, tenancy constraints, or combinations thereof.

In some embodiments, the allocation weights 312 may be used by a resource-allocation controller 314 to distribute one or more available computing resources 304 among the competing computational entities 302. In various embodiments, the one or more available computing resources 304 may include processor time, thread slots, execution windows, cache capacity, memory bandwidth, storage throughput, network bandwidth, accelerator occupancy, queue capacity, interconnect bandwidth, or combinations thereof.

In some embodiments, the amount of a given resource assigned to a given computational entity may be proportional to a recognition-derived allocation weight relative to the aggregate of corresponding allocation weights for other competing computational entities. In this manner, the disclosed resource-allocation process may provide a bounded and mathematically guided approach to sharing computing resources according to relative recognition significance.

In some embodiments, the resource-allocation controller 314 may first compute a raw recognition-derived weight for each computational entity and may then normalize the raw recognition-derived weights relative to an aggregate of corresponding raw recognition-derived weights for the other competing computational entities before assigning the one or more available computing resources 304. In this manner, the resulting allocations may remain bounded by a total available resource quantity for the relevant resource class.

In some embodiments, the resource-allocation controller 314 may further apply one or more minimum allocation constraints, maximum allocation constraints, fairness constraints, tenancy constraints, safety constraints, priority overrides, or combinations thereof after normalization of the recognition-derived weights. In some embodiments, any remaining unallocated quantity may be reserved for housekeeping operations, safety operations, background operations, or later reassignment.

In some embodiments, one or more feedback values 316 may be collected from the one or more shared computing resources 304 after allocation and execution. The one or more feedback values 316 may include realized throughput, observed latency, actual utilization, contention levels, occupancy levels, missed-service indicators, or combinations thereof. The one or more feedback values 316 may be used to update the one or more resource-relevant metrics 306, the one or more recognition metrics 308, and the one or more allocation weights 312 during continued operation.

Turning now to FIG. 4, an example recognition-based workload partition-sizing process is illustrated. In some embodiments, a workload 402 may be received for partitioning into a plurality of portions, chunks, segments, batches, tiles, windows, or sub-workloads. The workload 402 may correspond to a dataset, task collection, processing batch, computational graph portion, memory-transfer group, accelerator workload, or another divisible computational body.

In some embodiments, one or more workload-related metrics 404 may be determined for the workload 402. The one or more workload-related metrics 404 may include total workload size, estimated computational complexity, expected execution cost, dependency structure, data locality characteristics, memory footprint, bandwidth demand, or combinations thereof.

In some embodiments, the one or more workload-related metrics 404 may be normalized to produce one or more workload recognition metrics 406. One or more recognition coverage values 408 may then be computed from the one or more workload recognition metrics 406 using the recognition coverage function described herein.

In some embodiments, a partition-sizing controller 410 may determine one or more partition parameters from the one or more recognition coverage values 408. In various embodiments, the one or more partition parameters may include target partition size, target partition count, target sub-workload count, relative partition weights, balanced partition distributions, or combinations thereof.

In some embodiments, the partition-sizing controller 410 may produce a plurality of partitions 412 whose sizes collectively correspond to the workload 402 and whose individual sizes are determined, influenced, or bounded by the one or more recognition coverage values 408. In some embodiments, the partitions 412 may be substantially equal. In other embodiments, the partitions 412 may be intentionally unequal in order to reflect differences in predicted computational cost, data locality, downstream resource availability, or execution policy.

In some embodiments, the partitions 412 may be provided to one or more downstream schedulers, allocators, accelerators, processors, storage controllers, or distributed execution nodes. In this manner, the recognition-based partition-sizing process may influence not only partition geometry but also downstream scheduling efficiency, load balancing, communication overhead, and execution coordination.

In some embodiments, one or more feedback values 414 may be collected after processing of the partitions 412. The one or more feedback values 414 may include execution times, imbalance indicators, completion-order values, queue-delay values, locality-performance values, memory-usage values, or combinations thereof. The one or more feedback values 414 may be used to update one or more workload-related metrics 404 and subsequent partition determinations during later iterations or later workloads.

In one non-limiting example, the partition-sizing controller 410 may determine a raw partition-size target from total workload magnitude and a corresponding recognition-derived value, and may then determine an actual number of emitted partitions and corresponding emitted partition sizes so that the emitted partitions collectively cover the full workload while remaining consistent with the recognition-guided sizing objective. In some embodiments, the partition-sizing controller 410 may determine a target partition size according to PartSize_raw=N_total multiplied by F_cov(N_total), may determine a partition count according to K=ceil(N_total divided by PartSize_raw), and may then determine one or more emitted partition sizes based on dividing the workload among K partitions. In some embodiments, the emitted partition sizes may be substantially equal. In other embodiments, the emitted partition sizes may differ from one another based on locality characteristics, predicted execution cost, downstream resource availability, or execution policy.

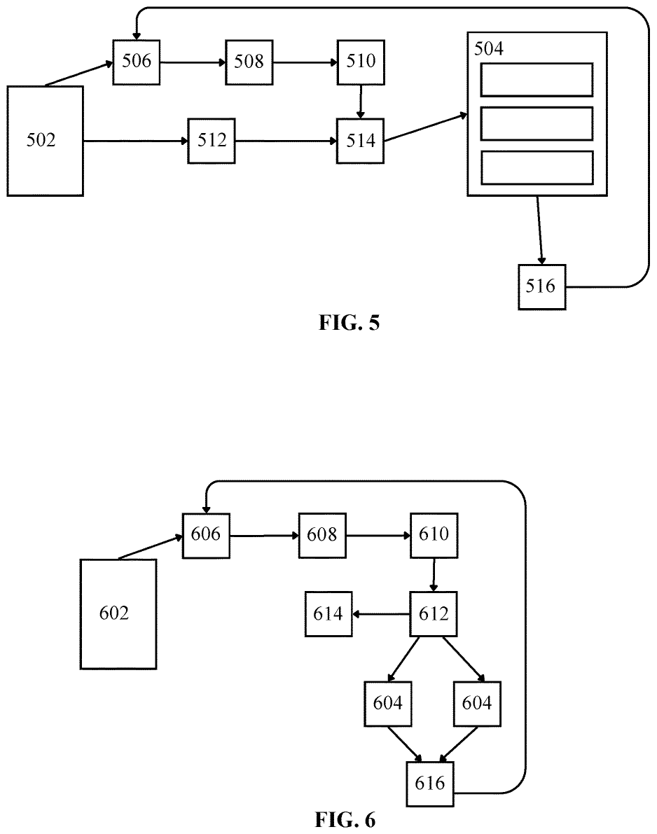

Turning now to FIG. 5, an example recognition-based hardware-allocation embodiment for reconfigurable hardware is illustrated. In some embodiments, one or more hardware functions, kernels, logic pipelines, accelerator tasks, or configurable workloads 502 may compete for one or more reconfigurable hardware resources 504.

In some embodiments, the one or more reconfigurable hardware resources 504 may include logic cells, lookup tables, configurable logic blocks, DSP slices, block memory resources, routing resources, clock regions, partial-reconfiguration regions, interconnect resources, or combinations thereof.

In some embodiments, one or more hardware-relevant metrics 506 may be determined for the respective hardware functions or workloads 502. The one or more hardware-relevant metrics 506 may include expected computational significance, estimated throughput benefit, latency sensitivity, memory demand, pipeline depth, signal-path importance, operating frequency sensitivity, utilization demand, or combinations thereof.

In some embodiments, the one or more hardware-relevant metrics 506 may be normalized to produce one or more hardware recognition metrics 508. One or more recognition coverage values 510 may then be computed from the one or more hardware recognition metrics 508 using the recognition coverage function described herein.

In some embodiments, one or more hardware-allocation weights 512 may be generated from the one or more recognition coverage values 510. The one or more hardware-allocation weights 512 may be used by a hardware-allocation controller 514 to determine how much of the available reconfigurable hardware resources 504 to assign to respective workloads 502.

In some embodiments, the hardware-allocation controller 514 may allocate logic resources, DSP resources, memory resources, routing resources, or combinations thereof proportionally, relatively, or otherwise responsively to the one or more hardware-allocation weights 512. In some embodiments, minimum reservation levels, maximum reservation levels, housekeeping reservations, thermal constraints, timing constraints, placement constraints, or other hardware policy constraints may also be applied.

In some embodiments, the hardware-allocation controller 514 may support static assignment, dynamic reassignment, partial reconfiguration, staged reconfiguration, preplanned region assignment, or combinations thereof. In this manner, reconfigurable hardware resources may be assigned using recognition-derived control values rather than solely by fixed floor plans or manual design heuristics.

In some embodiments, one or more feedback values 516 may be collected from the reconfigurable hardware resources 504 after configuration or execution. The one or more feedback values 516 may include utilization values, timing-closure values, throughput values, latency values, power-consumption values, thermal values, reconfiguration overhead values, or combinations thereof. The one or more feedback values 516 may be used to update the one or more hardware-relevant metrics 506 and later allocation decisions.

In some embodiments, recognition-based hardware allocation may be applied to a single hardware function or to multiple competing hardware functions. Where multiple competing hardware functions are present, the hardware-allocation controller 514 may determine relative shares of one or more hardware-resource classes based on respective recognition-derived values so that the resulting allocation remains bounded and comparable across the competing hardware functions.

In some embodiments, where multiple competing hardware functions are present, the hardware-allocation controller 514 may compute a respective raw recognition-derived weight for each hardware function and may normalize the respective raw recognition-derived weights relative to an aggregate of corresponding raw recognition-derived weights before assigning one or more hardware-resource classes. In this manner, logic-cell allocation, DSP allocation, memory allocation, routing allocation, or other hardware-resource allocation may remain bounded by the total available resources of the reconfigurable device.

In some embodiments, the hardware-allocation controller 514 may assign different resource classes independently so that one hardware function may receive a first relative share of logic resources, a second relative share of DSP resources, and a third relative share of memory resources based on one or more recognition-derived values and one or more hardware policy constraints. In some embodiments, one or more portions of the available device resources may remain reserved for timing closure, clocking structures, safety monitors, configuration logic, or housekeeping circuitry.

Turning now to FIG. 6, an example recognition-based accelerator-assignment embodiment is illustrated. In some embodiments, one or more computational entities 602 may be candidates for execution on one or more processing resources 604. The one or more processing resources 604 may include CPU cores, CPU core groups, GPU execution units, GPU streaming multiprocessors, tensor-processing elements, neural-processing units, accelerator tiles, neuromorphic pathways, neuromorphic cores, or combinations thereof.

In some embodiments, one or more accelerator-relevant metrics 606 may be determined for the respective computational entities 602. The one or more accelerator-relevant metrics 606 may include execution duration, expected throughput benefit, data-parallel suitability, occupancy demand, latency sensitivity, memory behavior, pathway strength, connection significance, spike influence, or combinations thereof.

In some embodiments, the one or more accelerator-relevant metrics 606 may be normalized to produce one or more accelerator recognition metrics 608. One or more recognition coverage values 610 may then be computed from the one or more accelerator recognition metrics 608 using the recognition coverage function described herein.

In some embodiments, one branch of FIG. 6 may correspond to multicore or GPU assignment, in which one or more recognition-derived values are used to determine assignment of processor cores, core groups, execution slots, accelerator tiles, or GPU resources among the computational entities 602.

In some embodiments, another branch of FIG. 6 may correspond to neuromorphic control, in which one or more recognition-derived values are used to determine scaling of synaptic strengths, connection weights, pathway influence values, spike-intensity-related variables, or other neural-computing parameters associated with one or more neuromorphic pathways or cores.

In some embodiments, an accelerator-assignment controller 612 may generate one or more assignment outputs 614 based on the one or more recognition coverage values 610. The one or more assignment outputs 614 may include processor-resource assignments, accelerator-resource assignments, pathway-scaling values, weight-scaling values, execution-placement decisions, or combinations thereof.

In some embodiments, one or more feedback values 616 may be collected after execution or pathway activity. The one or more feedback values 616 may include utilization values, execution times, throughput values, energy-consumption values, pathway-activity values, convergence indicators, or combinations thereof. The one or more feedback values 616 may be used to update the one or more accelerator-relevant metrics 606 and later assignment decisions.

In some embodiments, the disclosed accelerator-assignment embodiment may therefore unify multicore assignment, GPU assignment, accelerator placement, and neuromorphic pathway control under a shared recognition-based control framework while still permitting subsystem-specific implementation details within each branch.

Turning now to FIG. 7, an example recognition-based adaptive parameter optimization process is illustrated. In some embodiments, one or more operating parameters 702 may be selected for adaptive update during runtime operation of a computing system or subsystem.

In some embodiments, the one or more operating parameters 702 may include processor frequency, supply voltage, cache allocation, cache partition size, thread-pool size, queue depth, memory-bandwidth setting, storage parameter, accelerator-control parameter, cooling-control setting, or combinations thereof.

In some embodiments, one or more parameter-relevant metrics 704 may be determined for the one or more operating parameters 702. The one or more parameter-relevant metrics 704 may include performance values, latency values, throughput values, energy-consumption values, thermal values, utilization values, contention values, quality-of-service values, or combinations thereof.

In some embodiments, the one or more parameter-relevant metrics 704 may be normalized to produce one or more parameter recognition metrics 706. One or more recognition coverage values 708 may then be computed from the one or more parameter recognition metrics 706 using the recognition coverage function described herein.

In some embodiments, an adaptive optimization controller 710 may determine one or more updated parameter values 712 according to a recognition-derived update rule. In some embodiments, a current parameter value may be represented by a normalized parameter p, and the adaptive optimization controller 710 may update the normalized parameter according to p(t+1)=p(t)+alpha multiplied by X_opt divided by (p(t)+X_opt) squared, where alpha is a positive learning-rate parameter. In some embodiments, the adaptive optimization controller 710 may then convert the updated normalized parameter to a corresponding physical operating parameter including processor frequency, supply voltage, cache allocation, thread-pool size, queue depth, memory-bandwidth setting, storage setting, accelerator-control parameter, or combinations thereof. In some embodiments, the adaptive optimization controller 710 may clamp, quantize, bound, or otherwise constrain the updated parameter value to remain within one or more safe operating ranges.

In some embodiments, the adaptive optimization controller 710 may iteratively apply the updated parameter values 712 during runtime operation and may continue to receive one or more feedback values 714 reflecting the resulting system behavior. The one or more feedback values 714 may be used to update the one or more parameter-relevant metrics 704 and to perform further adaptive updates over time.

In some embodiments, the adaptive optimization controller 710 may compute one or more verification metrics from the post-update feedback values 714 and may compare the one or more verification metrics to one or more pre-update values, target values, threshold values, baseline values, or combinations thereof. In some embodiments, where a proposed update produces an undesired latency increase, throughput decrease, power increase, thermal increase, instability condition, or other policy violation, the adaptive optimization controller 710 may reduce the magnitude of a later update, revert to an earlier parameter value, apply a clamp value, or select another updated parameter value.

In some embodiments, the adaptive optimization controller 710 may perform updates periodically, at selected scheduling epochs, in response to threshold crossings, in response to workload changes, in response to thermal events, or in response to other runtime conditions.

In this manner, the recognition-based adaptive parameter optimization process may provide a mathematically guided and bounded alternative to purely ad hoc tuning loops, thereby enabling runtime adjustment of one or more operating parameters across processors, memory subsystems, accelerators, and related computing environments.

In some embodiments, use of the recognition-based control framework may improve operation of the computing system itself by reducing scheduler inefficiency, reducing resource-allocation imbalance, improving cache or memory utilization, improving accelerator utilization, improving hardware-resource distribution, or improving adaptive runtime control behavior relative to static, uniform, or independently tuned subsystem-specific control approaches. In this manner, the disclosed systems and methods may provide concrete improvements in operation of computing subsystems rather than merely classifying or presenting information.

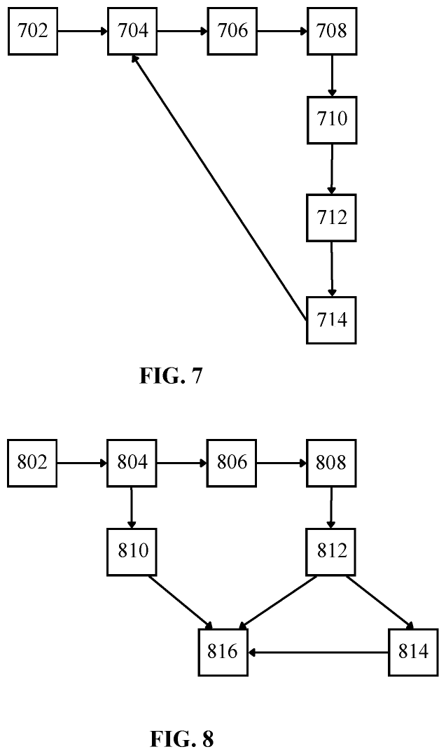

Turning now to FIG. 8, an example software and cloud implementation architecture is illustrated. In some embodiments, the disclosed recognition-based control framework may be embodied in one or more software modules 802, one or more firmware modules 804, one or more hardware interfaces 806, one or more runtime environments 808, one or more orchestration services 810, or combinations thereof.

In some embodiments, the one or more software modules 802 may be implemented as application-layer libraries, operating-system components, kernel modules, hypervisor components, container-runtime components, scheduler plug-ins, device drivers, middleware services, distributed control services, or combinations thereof.

In some embodiments, the one or more orchestration services 810 may be configured to operate within a cloud-computing environment, distributed-computing environment, cluster-computing environment, edge-computing environment, or hybrid-computing environment. In such embodiments, recognition-derived control values may be used to influence workload placement, resource scaling, service orchestration, accelerator assignment, or cross-node allocation decisions.

In some embodiments, one or more managed environments 812 may include virtual machines, containers, pods, serverless functions, distributed jobs, scheduler-managed workloads, accelerator-backed services, storage services, network services, or combinations thereof.

In some embodiments, one or more telemetry and feedback values 814 may be collected from the managed environments 812 and provided to one or more recognition-based control services 816 so that scheduling, allocation, optimization, or orchestration decisions may be updated during continued operation.

In some embodiments, the disclosed recognition-based control framework may therefore be deployed as a software library, as a local runtime service, as a cloud-hosted service, as a distributed orchestration controller, as firmware, as embedded control logic, or as a mixed implementation spanning multiple software and hardware layers.

In some embodiments, the disclosed recognition-based control framework may be implemented as an operating-system scheduler extension, a hypervisor control component, a container-orchestration plug-in, a device-driver extension, a runtime library, a middleware controller, a distributed resource broker, or combinations thereof. In some embodiments, the framework may receive measured runtime values from kernel counters, performance-monitoring units, accelerator telemetry interfaces, storage telemetry interfaces, network telemetry interfaces, or combinations thereof, and may generate machine-control outputs that directly affect scheduling, allocation, hardware assignment, runtime configuration, or orchestration behavior.

In some embodiments, the disclosed systems and methods may be implemented using one or more processors configured by executable instructions stored on one or more non-transitory computer-readable media. In some embodiments, the executable instructions may cause the one or more processors to perform one or more of the metric-determination, normalization, recognition-coverage computation, scheduling, allocation, partitioning, assignment, optimization, feedback-processing, or orchestration operations described herein.

In some embodiments, the disclosed systems and methods may also be implemented in dedicated hardware logic, reconfigurable logic, firmware, or combinations thereof. Accordingly, the present invention is not limited to any particular implementation layer, programming model, hardware platform, or deployment environment.

Although specific embodiments have been described for purposes of illustration, it will be understood that various modifications, substitutions, rearrangements, and combinations may be made without departing from the spirit and scope of the invention. For example, different normalization procedures, different recognition metrics, different subsystem combinations, different hardware targets, different orchestration models, and different update strategies may be used in various embodiments.

It will further be understood that features described in connection with one embodiment may be combined with features described in connection with another embodiment unless expressly stated otherwise. Accordingly, the foregoing description is intended to be illustrative rather than limiting.

What is claimed is:

1. A recognition-based computing system, comprising:
one or more processors; and
a memory storing instructions that, when executed by the one or more processors, cause the system to:
determine, for each of a plurality of computational entities, a respective metric from one or more measured, estimated, inferred, predicted, or profiled quantities associated with the respective computational entity;
determine a metric_scale that is strictly positive;
normalize the respective metric using the metric_scale to obtain a dimensionless recognition metric r;
compute, from the dimensionless recognition metric r, a recognition coverage value according to F_cov(r)=r/(r+X_opt), where X_opt is a positive informational scale;
generate, from the recognition coverage value, one or more machine-control outputs that directly control operation of at least one computing subsystem; and
control the at least one computing subsystem according to the one or more machine-control outputs.

2. The system of claim 1, wherein X_opt=phi/pi.

3. The system of claim 1, wherein the one or more measured, estimated, inferred, predicted, or profiled quantities comprise one or more of instruction count, expected execution time, queue depth, dependency count, memory footprint, cache-access value, reuse value, bandwidth demand, accelerator occupancy, pathway strength, temperature, power consumption, latency, or throughput.

4. The system of claim 1, wherein the one or more machine-control outputs comprise one or more task-priority values used by the task scheduling subsystem to control dispatch order, execution timing, queue selection, or preemption behavior for a plurality of tasks.

5. The system of claim 1, wherein the one or more machine-control outputs comprise one or more allocation weights used by the resource-allocation subsystem to distribute one or more shared computing resources among a plurality of competing computational entities.

6. The system of claim 5, wherein the one or more shared computing resources comprise one or more of processor time, thread slots, cache capacity, memory bandwidth, storage throughput, network bandwidth, accelerator occupancy, queue capacity, or interconnect bandwidth.

7. The system of claim 1, wherein the one or more machine-control outputs comprise one or more partition parameters used by the workload partition-sizing subsystem to determine one or more partition sizes, partition counts, or sub-workload distributions for a workload.

8. The system of claim 1, wherein the one or more machine-control outputs comprise one or more hardware-allocation outputs used by the reconfigurable hardware-allocation subsystem to allocate reconfigurable hardware resources among a plurality of hardware functions or workloads.

9. The system of claim 8, wherein the reconfigurable hardware resources comprise one or more of logic cells, lookup tables, configurable logic blocks, DSP slices, block memory resources, routing resources, clock regions, or partial-reconfiguration regions.

10. The system of claim 1, wherein the one or more machine-control outputs comprise one or more accelerator-assignment outputs used to assign one or more computational entities to one or more processing resources comprising one or more of CPU cores, CPU core groups, GPU execution units, GPU streaming multiprocessors, neural-processing units, accelerator tiles, neuromorphic pathways, or neuromorphic cores.

11. The system of claim 1, wherein the instructions further cause the system to compute a verification metric after applying the one or more machine-control outputs, and to retain, reduce, revert, or clamp a later machine-control output based on comparing the verification metric to a baseline, target, or threshold.

12. The system of claim 1, wherein the one or more machine-control outputs comprise one or more updated operating-parameter values generated by the adaptive parameter optimization subsystem during runtime operation.

13. The system of claim 12, wherein the one or more updated operating-parameter values comprise one or more of processor frequency, supply voltage, cache allocation, cache partition size, thread-pool size, queue depth, memory-bandwidth setting, storage parameter, accelerator-control parameter, or cooling-control setting.

14. The system of claim 1, wherein the system is configured to receive one or more feedback values from the at least one computing subsystem, compute a verification metric from the one or more feedback values, and update one or more later machine-control outputs based on comparing the verification metric to a baseline, target, or threshold.

15. A computer-implemented method for recognition-based computing control, comprising:
determining, for each of a plurality of computational entities, a respective metric from one or more measured, estimated, inferred, predicted, or profiled quantities associated with the respective computational entity;
determining a metric_scale that is strictly positive;
normalizing the respective metric using the metric_scale to obtain a dimensionless recognition metric r;
computing, from the dimensionless recognition metric r, a recognition coverage value according to F_cov(r)=r/(r +X_opt), where X_opt is a positive informational scale;
generating, from the recognition coverage value, one or more machine-control outputs that directly control operation of at least one computing subsystem; and
controlling the at least one computing subsystem according to the one or more machine-control outputs.

16. The method of claim 15, wherein controlling the one or more computing subsystems comprises assigning one or more task-priority values to a plurality of tasks and dispatching the plurality of tasks according to the one or more task-priority values.

17. The method of claim 15, wherein controlling the one or more computing subsystems comprises distributing one or more shared computing resources among a plurality of competing computational entities according to one or more recognition-derived allocation weights.

18. The method of claim 15, wherein controlling the one or more computing subsystems comprises determining one or more partition parameters for dividing a workload into a plurality of partitions.

19. A non-transitory computer-readable medium storing instructions that, when executed by one or more processors, cause the one or more processors to:
determine, for each of one or more computational entities, a respective metric from one or more measured, estimated, inferred, predicted, or profiled quantities;
determine a metric_scale that is strictly positive;
normalize the respective metric using the metric_scale to obtain a dimensionless recognition metric r;
compute a recognition coverage value according to F_cov(r)=r/(r+X_opt), where X_opt is a positive informational scale;
generate, from the recognition coverage value, one or more machine-control outputs that directly control operation of at least one computing subsystem; and
control the at least one computing subsystem using the one or more machine-control outputs.

20. The non-transitory computer-readable medium of claim 19, wherein determining the one or more metrics and computing the one or more recognition coverage values are performed periodically according to a scheduling epoch.
